(19) United States
(12) Patent Application Publication
(10) Pub. No.: US 2010/0245561 A1
(43) Pub. Date: Sep. 30, 2010

(54) NAVIGATION DEVICE

(76) Inventors: Yoshihisa Yamaguchi, Tokyo (JP); Takashi Nakagawa, Tokyo (JP); Toyoaki Kitano, Tokyo (JP); Hideto Miyazaki, Tokyo (JP); Tsutomu Matsubara, Tokyo (JP)

Correspondence Address: BIRCH STEWART KOLASCH & BIRCH, PO BOX 747, FALLS CHURCH, VA, 22040-0747, US

(21) Appl. No.: 12/742,719

(22) PCT Filed: Sep. 10, 2008
(86) PCT No.: PCT/JP2008/002500

§ 371 Date: May 13, 2010

(30) Foreign Application Priority Data
Dec. 28, 2007 (JP) 2007-339733

(51) Int. Cl. H04N 9/74

(52) U.S. Cl. 348/118; 348/E09.055

(57) ABSTRACT

A navigation device includes: a map database 5 that holds map data; a location and direction measurement unit 4 that measures the current location and direction of a vehicle; a road data acquisition unit that 16 that acquires, from the map database, map data of the surroundings of the location measured by the location and direction measurement unit, and that gathers road data from the map data; a camera 7 that captures video images ahead of the vehicle; a video image acquisition unit 8 that acquires the video images ahead of the vehicle captured by the camera; a video image composition processing unit 14 that creates a video image in which a picture of a road denoted by road data gathered by the road data acquisition unit is superimposed on the video image acquired by the video image acquisition unit; and a display unit 10 that displays the video image created by the video image composition processing unit.

### TECHNICAL FIELD

The present invention relates to a navigation device that guides a user to a destination, and more particularly to a technology for displaying guidance information on live-action or real video that is captured by a camera.

### BACKGROUND ART

Known technologies in conventional car navigation devices include, for instance, route guidance technologies in which an on-board camera captures images ahead of a vehicle during cruising, and guidance information, in the form of CG (Computer Graphics), is displayed with being overlaid on video obtained through the above image capture (for instance, Patent Document 1).

Also, as a similar technology, Patent Document 2 discloses a car navigation device in which navigation information elements are displayed so as to be readily grasped intuitively. In this car navigation device, an imaging camera attached to the nose or the like of a vehicle captures the background in the travel direction, in such a manner that a map image and a live-action video with respect to background display of navigation information elements can be selected by a selector, and the navigation information elements are displayed on a display device with being overlaid on the background image by way of an image composition unit. Patent document 2 discloses a technology wherein, during guidance of a vehicle along a route, an arrow is displayed at intersections along the road in which the vehicle is guided using a live-action video image.

Patent Document 1: Japanese Patent No. 2915508

Patent Document 2: Japanese Patent Application Publication No. 11-108684 (JP-A-11-108684)

Safer driving could be achieved if it were possible to grasp not only the area visible from the vehicle, as is ordinarily the case, but also the shape of the road around the vehicle, since that would allow taking a detour or altering the route, thereby increasing the margin of the driving operation. In the technologies disclosed in Patent document 1 and Patent document 2, however, route guidance is performed using a live-action video image, and hence, although the situation ahead of the vehicle can be learned in detail, it is not possible to grasp the shape of the road around the vehicle. It would therefore be desirable to develop a car navigation device that should enable safer driving by making it possible to grasp the shape of the road around the vehicle.

The present invention is made to meet the above requirements, and it is an object of the present invention to provide a navigation device that affords safer driving.

### DISCLOSURE OF THE INVENTION

In order to solve the above problem, a navigation device according to the present invention includes: a map database that holds map data; a location and direction measurement unit that measures a current location and direction of a vehicle; a road data acquisition unit that acquires, from the map database, map data of the surroundings of the location measured by the location and direction measurement unit, and that gathers road data from the map data; a camera that captures video images ahead of the vehicle; a video image acquisition unit that acquires the video images ahead of the vehicle that are captured by the camera; a video image composition processing unit that creates a video image in which a picture of a road denoted by road data gathered by the road data acquisition unit is superimposed on the video image acquired by the video image acquisition unit; and a display unit that displays the video image created by the video image composition processing unit.

According to the navigation device of the present invention, since it is configured in such a manner that a picture of the road around the current location is displayed on a display unit with being superimposed on video images ahead of the vehicle captured by a camera, the driver can grasp the shape or geometry of the road at non-visible locations around the vehicle, which enables safer driving.

### BRIEF DESCRIPTION OF THE DRAWINGS

FIG. 1 is a block diagram showing the configuration of a car navigation device according to Embodiment 1 of the present invention;

FIG. 2 is a flowchart illustrating the operation of the car navigation device according to Embodiment 1 of the present invention, focusing on a video image composition process;

FIG. 3 is a diagram showing an example of video images before and after composition of a road into live-action video image in the car navigation device according to Embodiment 1 of the present invention;

FIG. 4 is a flowchart illustrating the details of a content creation process in the video image composition process that is carried out in the car navigation device according to Embodiment 1 of the present invention;

FIG. 5 is a diagram for illustrating the types of content used in the car navigation device according to Embodiment 1 of the present invention;

FIG. 6 is a flowchart illustrating the details of a content creation process in the video image composition process that is carried out in the car navigation device according to Embodiment 2 of the present invention;

FIG. 7 is a diagram for illustrating consolidation in the content creation process in the video image composition process that is carried out in the car navigation device according to Embodiment 2 of the present invention;

FIG. 8 is a flowchart illustrating the details of a content creation process in the video image composition process that is carried out in the car navigation device according to Embodiment 3 of the present invention;

FIG. 9 is a flowchart illustrating the operation of the car navigation device according to Embodiment 4 of the present invention, focusing on a video image composition process;

FIG. 10 is a flowchart illustrating the operation of the car navigation device according to Embodiment 5 of the present invention, focusing on a video image composition process;

FIG. 11 is a diagram showing an example of video images in which an intersection is composed onto a live-action video image in the car navigation device according to Embodiment 5 of the present invention;

FIG. 12 is a flowchart illustrating the operation of the car navigation device according to Embodiment 6 of the present invention, focusing on a video image composition process;

FIG. 13-1 is a diagram showing an example of video images in which a road is highlighted on a live-action video image in the car navigation device according to Embodiment 6 of the present invention; and

FIG. 13-2 is a diagram showing another example of video images in which a road is highlighted on a live-action video image in the car navigation device according to Embodiment 6 of the present invention.

### BEST MODE FOR CARRYING OUT THE INVENTION

The present invention is explained in detail below on the basis of preferred embodiments for realizing the invention, with reference to accompanying drawings.

### Embodiment 1

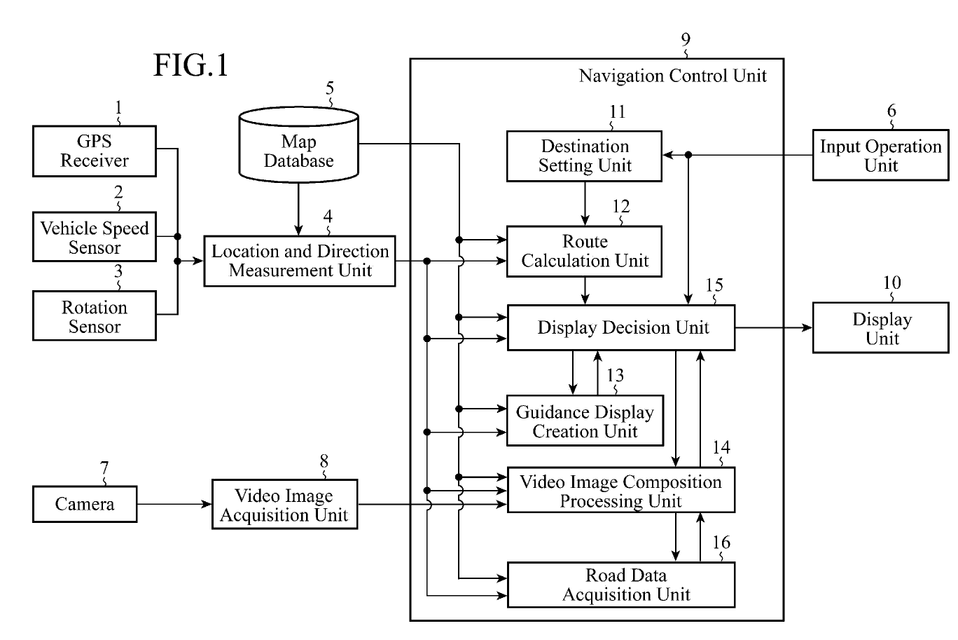

FIG. 1 is a block diagram showing the configuration of a navigation device according to Embodiment 1 of the present invention, in particular a car navigation device used in a vehicle. The car navigation device includes a GPS (Global Positioning System) receiver 1, a vehicle speed sensor 2, a rotation sensor (gyroscope) 3, a location and direction measurement unit 4, a map database 5, an input operation unit 6, a camera 7, a video image acquisition unit 8, a navigation control unit 9 and a display unit 10.

The GPS receiver 1 measures a vehicle location by receiving radio waves from a plurality of satellites. The vehicle location measured by the GPS receiver 1 is sent as a vehicle location signal to the location and direction measurement unit 4. The vehicle speed sensor 2 sequentially measures the speed of the vehicle. The vehicle speed sensor 2 is generally composed of a sensor that measures tire revolutions. The speed of the vehicle measured by the vehicle speed sensor 2 is sent as a vehicle speed signal to the location and direction measurement unit 4. The rotation sensor 3 sequentially measures the travel direction of the vehicle. The traveling direction (hereinafter, simply referred to as “direction”) of the vehicle as measured by the rotation sensor 3 is sent as a direction signal to the location and direction measurement unit 4.

The location and direction measurement unit 4 measures the current location and direction of the vehicle on the basis of the vehicle location signal sent from the GPS receiver 1. However, in the cases where the space over the vehicle is blocked by, for instance, a tunnel or surrounding buildings, the number of satellites from which radio waves can be received is zero or reduced, and thereby a reception status thereof may be impaired. The current location and direction cannot be measured on the basis of the vehicle location signal alone from the GPS receiver 1, or even if the measurement is possible, the precision thereof may be deteriorated. Therefore, the vehicle location is measured by taking advantage of dead reckoning (autonomous navigation) using the vehicle speed signal from the vehicle speed sensor 2 and the direction signal from the rotation sensor 3 to thus carry out processing for compensating measurements according to the GPS receiver 1.

As mentioned above, the current location and direction of the vehicle as measured by the location and direction measurement unit 4 contains various errors that arise from, for instance, impaired measurement precision due to poor reception by the GPS receiver 1, or vehicle speed errors on account of changes in tire diameter, caused by wear and/or temperature changes, or errors attributable to the precision of the sensors themselves. The location and direction measurement unit 4, therefore, corrects the current location and direction of the vehicle, obtained by measurement and which contains errors, by map-matching using road data acquired from the map database 5. The corrected current location and direction of the vehicle are sent, as vehicle location and direction data, to the navigation control unit 9.

The map database 5 holds map data that includes road data such as road location, road type (expressway, toll road, ordinary road, narrow street and the like), restrictions relating to the road (speed restrictions, one-way traffic and the like), or lane information in the vicinity of an intersection, as well as information on facilities around the road. Roads are represented as a plurality of nodes and straight line links that join the nodes. Road location is expressed by recording the latitude and longitude of each node. For instance, three or more links connected in a given node indicate a plurality of roads that intersect at the location of the node. The map data held in the map database 5 is read by the location and direction measurement unit 4, as described above, and also by the navigation control unit 9.

The input operation unit 6 is composed of at least one from among, for instance, a remote controller, a touch panel, and/or a voice recognition device. The input operation unit 6 is operated by the user, i.e. the driver or a passenger, for inputting a destination, or for selecting information supplied by the car navigation device. The data created through operation of the input operation unit 6 is sent, as operation data, to the navigation control unit 9.

The camera 7 is composed of at least one from among, for instance, a camera that captures images ahead of the vehicle, or a camera capable of capturing images simultaneously over a wide range of directions, for instance, all-around the vehicle. The camera 7 captures images of the surroundings of the vehicle, including the travel direction of the vehicle. The video signal obtained through capturing by the camera 7 is sent to the video image acquisition unit 8.

The video image acquisition unit 8 converts the video signal sent from the camera 7 into a digital signal that can be processed by a computer. The digital signal obtained through conversion by the video image acquisition unit 8 is sent, as video data, to the navigation control unit 9.

The navigation control unit 9 carries out data processing in order to provide a function for displaying a map of the surroundings of the vehicle in which the car navigation device is provided, wherein the function may include calculating a guidance route up to a destination inputted via the input operation unit 6, creating guidance information in accordance with the guidance route and the current location and direction of the vehicle, or creating a guide map that combines a map of the surroundings of the vehicle location and a vehicle mark that denotes the vehicle location; and a function of guiding the vehicle to the destination. In addition, the navigation control unit 9 carries out data processing for searching information such as traffic information, sightseeing sites, restaurants, shops and the like relating to the destination or to the guidance route, and for searching facilities that match the conditions inputted through the input operation unit 6.

The navigation control unit 9 creates display data for displaying, singly or in combination, a map created on the basis of map data read from the map database 5, video images denoted by the video data acquired by the video image acquisition unit 8, or images composed by an own internal video image composition processing unit 14 (described below in detail). The navigation control unit 9 is described in detail below. The display data created as a result of the various processes in the navigation control unit 9 is sent to the display unit 10.

The display unit 10 is composed of, for instance, an LCD (Liquid Crystal Display), and displays the display data sent from the navigation control unit 9 in the form of, for instance, a map and/or live-action vide, on screen.

Next, the details of the navigation control unit 9 will be described below. The navigation control unit 9 includes a destination setting unit 11, a route calculation unit 12, a guidance display creation unit 13, a video image composition processing unit 14, a display decision unit 15 and a road data acquisition unit 16. To prevent cluttering, some of the connections between the various constituent elements above have been omitted in FIG. 1. The omitted portions will be explained as they appear.

The destination setting unit 11 sets a destination in accordance with the operation data sent from the input operation unit 6. The destination set by the destination setting unit 11 is sent as destination data to the route calculation unit 12.

The route calculation unit 12 calculates a guidance route up to the destination on the basis of destination data sent from the destination setting unit 11, vehicle location and direction data sent from the location and direction measurement unit 4, and map data read from the map database 5. The guidance route calculated by the route calculation unit 12 is sent, as guidance route data, to the display decision unit 15.

In response to an instruction by the display decision unit 15, the guidance display creation unit 13 creates a guide map (hereinafter, referred to as “chart-guide map”) based on a chart used in conventional car navigation devices. The chart-guide map created by the guidance display creation unit 13 includes various guide maps that do not utilize a live-action video image, for instance planimetric maps, intersection close-up maps, highway schematic maps and the like. The chart-guide map is not limited to a planimetric map, and may be a guide map employing three-dimensional CG, or a guide map that is a bird's-eye view of a planimetric map. Techniques for creating a chart-guide map are well known, and a detailed explanation thereof will be omitted. The chart-guide map created by the guidance display creation unit 13 is sent as chart-guide map data to the display decision unit 15.

In response to an instruction from the display decision unit 15, the video image composition processing unit 14 creates a guide map that uses a live-action video image (hereinafter, referred to as “live-action guide map”). For instance, the video image composition processing unit 14 acquires, from the map database 5, information on nearby objects around the vehicle, such as road networks, landmarks and intersections, and creates a live-action guide map in which there are overlaid a graphic for describing the shape, purport and the like of nearby objects, as well as character strings, images and the like (hereinafter, referred to as “content”), around the nearby objects that are present in a live-action video image that is represented by the video data sent from the video image acquisition unit 8.

The video image composition processing unit 14 creates a live-action guide map in which a picture of the road denoted by road data gathered by the road data acquisition unit 16 is superimposed on a live-action video image acquired by the video image acquisition unit 8. The live-action guide map created by the video image composition processing unit 14 is sent, as live-action guide map data, to the display decision unit 15.

As mentioned above, the display decision unit 15 instructs the guidance display creation unit 13 to create a chart-guide map, and instructs the video image composition processing unit 14 to create a live-action guide map. Also, the display decision unit 15 decides the content to be displayed on the screen of the display unit 10 on the basis of vehicle location and direction data sent from the location and direction measurement unit 4, map data of the vehicle surroundings read from the map database 5, operation data sent from the input operation unit 6, chart-guide map data sent from the guidance display creation unit 13 and live-action guide map data sent from the video image composition processing unit 14. The data corresponding to the display content decided by the display decision unit 15 is sent as display data to the display unit 10.

On the basis of the display data, the display unit 10 displays, for instance, an intersection close-up view, when the vehicle approaches an intersection, or displays a menu when a menu button of the input operation unit 6 is pressed, or displays a live-action guide map, using a live-action video image, when a live-action display mode is set by the input operation unit 6. Switching to a live-action guide map that uses a live-action video image can be configured to take place also when the distance to an intersection at which the vehicle is to turn is equal to or smaller than a given value, in addition to when a live-action display mode is set.

The guide map displayed on the screen of the display unit 10 can be configured so as to display simultaneously, in one screen, a live-action guide map and a chart-guide map such that the chart-guide map (for instance, a planimetric map) created by the guidance display creation unit 13 is disposed on the left of the screen, and a live-action guide map (for instance, an intersection close-up view using a live-action video image) created by the video image composition processing unit 14 is disposed on the right of the screen.

In response to an instruction by the video image composition processing unit 14, the road data acquisition unit 16 acquires, from the map database 5, road data (road link) of the surroundings of the vehicle location denoted by the location and direction data sent from the location and direction measurement unit 4. The road data gathered by the road data acquisition unit 16 is sent to the video image composition processing unit 14.

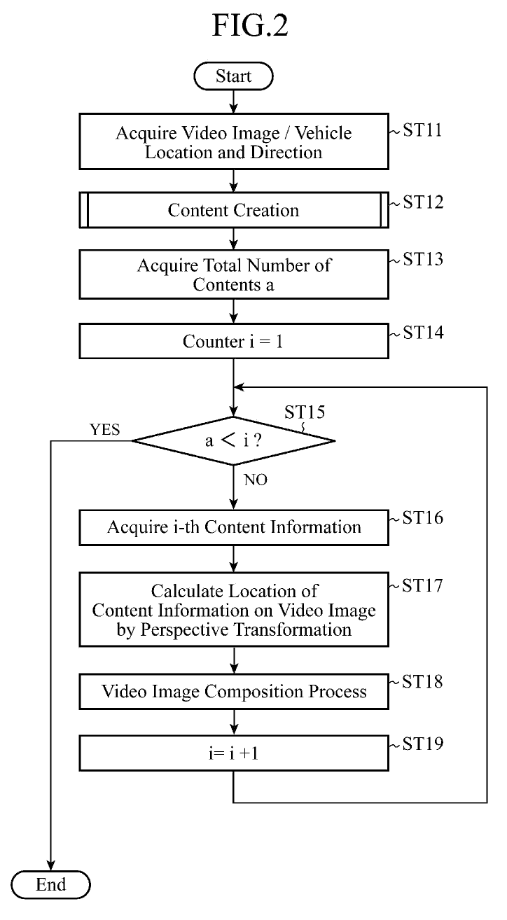

Next, the operation of the car navigation device in accordance with Embodiment 1 of the present invention having the above features will be described with focusing on the video image composition process that is carried out in the video image composition processing unit 14 with reference to the flowchart illustrated in FIG. 2.

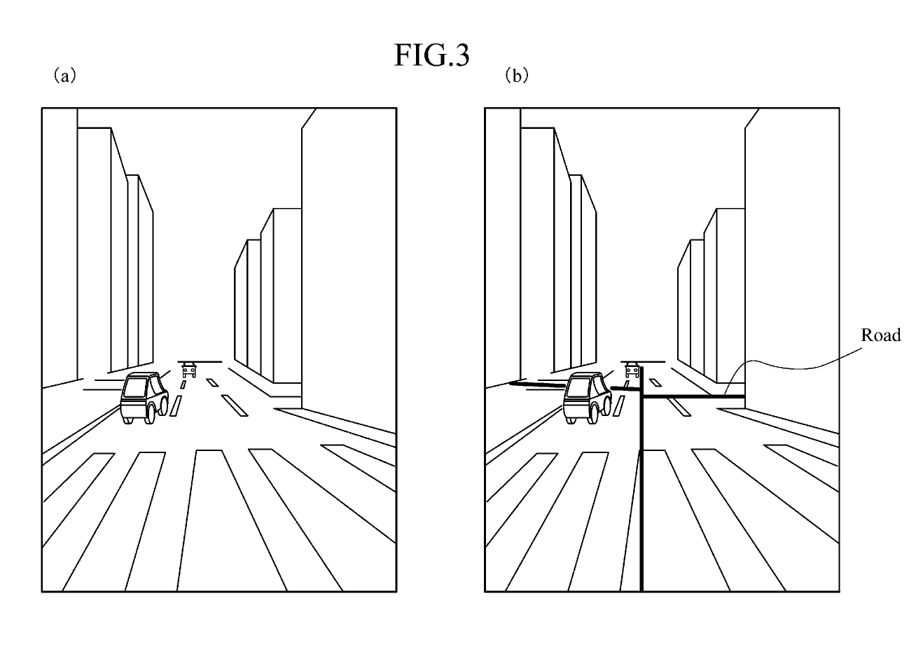

In the video image composition process, video images as well as the vehicle location and direction are first acquired (step ST11). Specifically, the video image composition processing unit 14 acquires vehicle location and direction data from the location and direction measurement unit 4, and also video data created at that point in time by the video image acquisition unit 8. The video images denoted by the video data acquired in step ST11 are, for instance, live-action video images, such as the one illustrated in FIG. 3(a).

Then, content creation is carried out (step ST12). Specifically, the video image composition processing unit 14 searches for nearby objects of the vehicle in the map database 5, and creates, from among the searched nearby objects, content information that is to be presented to the user. In the content information, the content to be presented to the user, such as a route along which the vehicle is guided, as well as the road network, landmarks, intersections and the like around the vehicle, is represented as a graphic, a character string or an image, compiled with coordinates for displaying the foregoing. The coordinates are given, for instance, by a coordinate system (hereinafter, referred to as “reference coordinate system”) that is uniquely determined on the ground, for instance latitude and longitude. In the case of a graphic, the coordinates are given by the coordinates of each vertex in the reference coordinate system, and in the case of character strings or images, the coordinates are given by the coordinates that serve as a reference for displaying the character strings and images.

Additionally, the video image composition processing unit 14 gathers the road data acquired by the road data acquisition unit 16, and adds the road data as supplementary content information. In step ST12 there is decided the content to be presented to the user, as well as the total number of contents a. The particulars of the content creation process that is carried out in step ST12 are explained in detail further on.

Then, the total number of contents a is acquired (step ST13). Specifically, the video image composition processing unit 14 acquires the total number of contents a created in step ST12. Then, the video image composition processing unit 14 initializes the value i of the counter to “1” (step ST14). Specifically, the value of the counter for counting the number of contents already composed is set to “1”. Note that the counter is provided in the video image composition processing unit 14.

Then, it is checked whether the composition process is over for all the pieces of content information (step ST15). Specifically, the video image composition processing unit 14 determines whether the number of contents i already composed, which is the value of the counter, is greater than the total number of contents a. When in step ST15 it is determined that the number of contents i already composed is greater than the total number of contents a, the video image composition process is terminated, and the video data having content composed therein at that point in time is sent to the display decision unit 15.

On the other hand, when in step ST15 it is determined that the number of contents i already composed is not greater than the total number of contents a, there is acquired i-th content information (step ST16). Specifically, the video image composition processing unit 14 acquires an i-th content information item from among the content information created in step ST12.

Then, there is calculated the location of the content information on the video image, through perspective transformation (step ST17). Specifically, the video image composition processing unit 14 calculates the location of the content on the video image acquired in step ST11, in the reference coordinate system in which the content is to be displayed, on the basis of the vehicle location and direction acquired in step ST11 (location and direction of the vehicle in the reference coordinate system); the location and direction of the camera 7 in the coordinate system referenced to the vehicle; and characteristic values of the camera 7 acquired beforehand, such as field angle and focal distance. The above calculation is identical to a coordinate transform calculation called perspective transformation.

Then, a video image composition process is carried out (step ST18). Specifically, the video image composition processing unit 14 draws a graphic, character string, image or the like denoted by the content information, acquired in step ST16, onto the video image acquired in step ST11, at the location calculated in step ST17. As a result there is created a video image in which a picture of the road is overlaid on a live-action video image, as illustrated in FIG. 3(b).

Then, the value i of the counter is then incremented (step ST19). Specifically, the video image composition processing unit 14 increments the value i of the counter. The sequence returns thereafter to step ST15, and the above-described process is repeated.

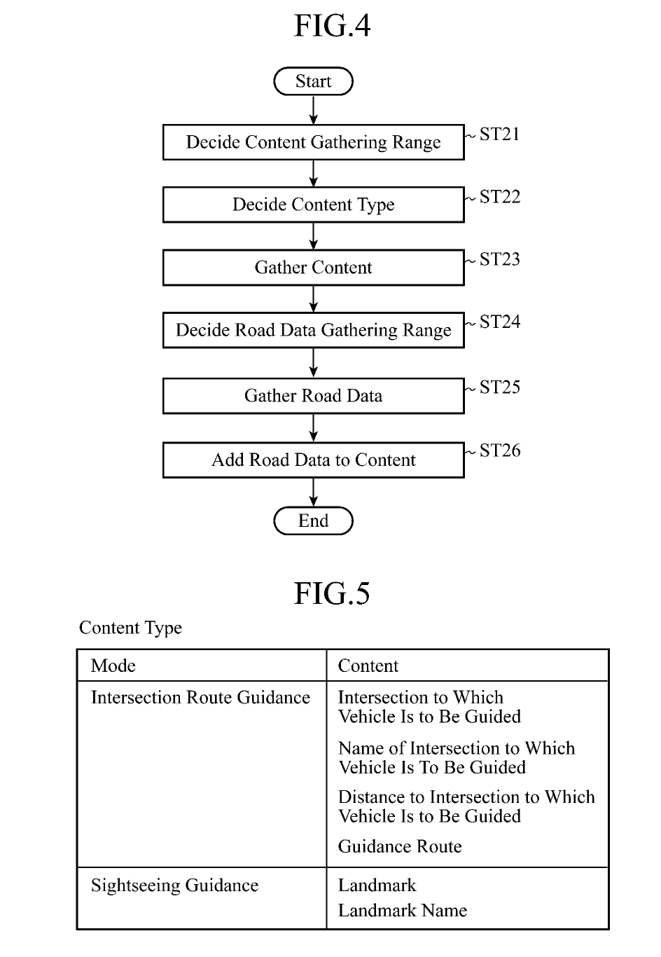

Next, the details of the content creation process that is carried out in step ST12 of the above-described video image composition process will be described with reference to the flowchart illustrated in FIG. 4.

In the content creation process there is decided first the range over which content is to be gathered (step ST21). Specifically, the video image composition processing unit 14 establishes the range over which content is to be gathered, for instance, as within a circle having a radius of 50 m around the vehicle, or a square extending 50 m ahead of the vehicle and 10 m to the left and right of the vehicle. The range over which content is to be gathered may be set beforehand by the manufacturer of the car navigation device, or may be arbitrarily set by the user.

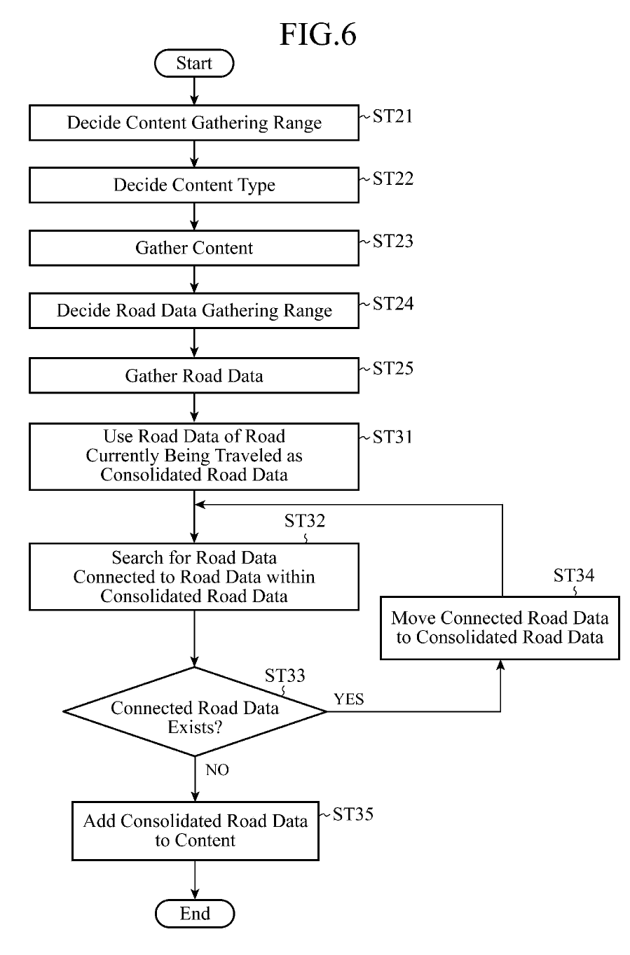

Then, the type of content to be gathered is decided (step ST22). The type of content to be gathered can vary depending on the guidance mode, for instance, as illustrated in FIG. 5. The video image composition processing unit 14 decides the type of content to be gathered in accordance with the guidance mode. The content type may be set beforehand by the manufacturer of the car navigation device, or may be arbitrarily selected by the user.

Then, gathering of contents is carried out (step ST23). Specifically, the video image composition processing unit 14 gathers, from the map database 5 or from other processing units, a content of the type decided in step ST22 among those existing within the range decided in step ST21.

Then, a range over which road data is to be gathered is decided (step ST24). Specifically, the video image composition processing unit 14 establishes the range of the road data to be acquired, for instance, as within a circle having a radius of 50 m around the vehicle, or a square extending 50 m ahead of the vehicle and 10 m to the left and right of the vehicle, and sends the range to the road data acquisition unit 16. The range over which road data is to be gathered may be the same as the range over which content is to be gathered, as decided in step ST21, or may be a different range.

Then, road data is gathered (step ST25). In response to an instruction from the video image composition processing unit 14, the road data acquisition unit 16 gathers road data existing within the range over which road data is to be gathered, as decided in step ST24, and sends the gathered road data to the video image composition processing unit 14.

Then, the content is supplemented with road data (step ST26). Specifically, the video image composition processing unit 14 adds the road data gathered in step ST25 to the content. This completes the content creation process, and the sequence returns to the video image composition process.

However, the above-described video image composition processing unit 14 is configured so as to compose content onto a video image using a perspective transformation, but may also be configured so as to recognize targets within the video image, by subjecting the video image to an image recognition process, and by composing content onto the recognized video image.

In the car navigation device according to Embodiment 1 of the present invention, as explained above, a picture of the road around the vehicle is displayed overlaid onto a live-action video image of the surroundings of the vehicle, captured by the camera 7, within the screen of the display unit 10. As a result, driving can be made safer in that the driver can learn the shape of the road at non-visible positions around the vehicle.

### Embodiment 2

Except for the function of the video image composition processing unit 14, the configuration of the car navigation device according to Embodiment 2 of the present invention is identical to that of the car navigation device according to Embodiment 1 illustrated in FIG. 1. The video image composition processing unit 14 creates a live-action guide map in which a road denoted by road data used in a final rendering, namely road data after, for instance, removing overpasses (high level roads) or merging roads (hereinafter, referred to as “consolidated road data”), from among data gathered by the road data acquisition unit 16 (hereinafter, referred to as “gathered road data”), is overlaid on the live-action video image acquired by the video image acquisition unit 8.

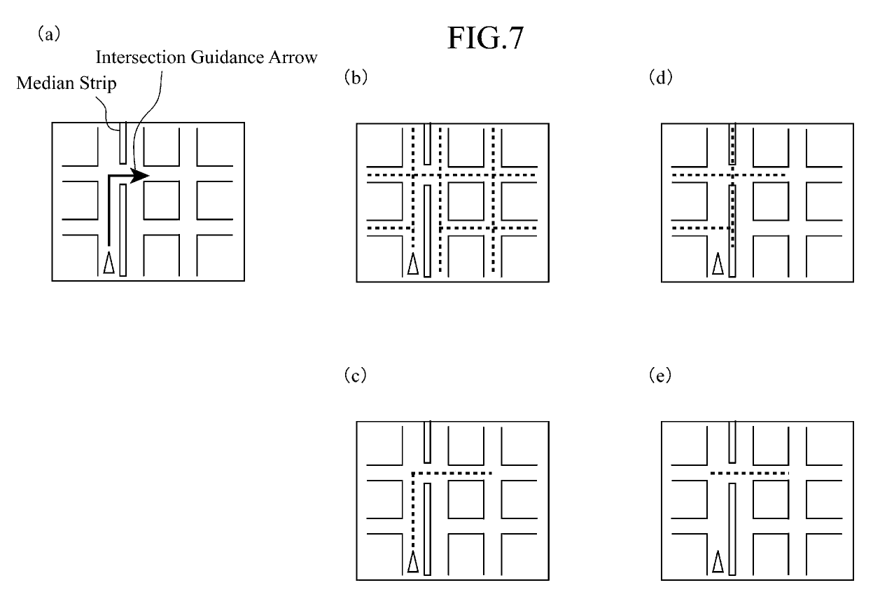

Except for the content creation process carried out in step ST12, the video image composition process performed by the car navigation device according to Embodiment 2 is identical to the video image composition process performed by the car navigation device according to Embodiment 1 illustrated in FIG. 2. In the following the details of the content creation process differing from that of Embodiment 1 will be described with reference to the flowchart illustrated in FIG. 6, by way of an example of a process of eliminating roads such as overpasses or the like that are not connected to a road of interest. However, the steps where the same process is carried out as in the content creation process of the car navigation device according to Embodiment 1 illustrated in FIG. 4 are denoted with the same reference numerals as those used in Embodiment 1, and the explanation thereof with be simplified.

In the content creation process, firstly, there is decided the range over which content is to be gathered (step ST21). Then, the type of content to be gathered is decided (step ST22). Then, the content is gathered (step ST23). Then, there is decided the range over which road data is to be gathered (step ST24). Then, road data is gathered (step ST25).

Then, the data on the road currently being traveled is used as consolidated road data (step ST31). Specifically, the video image composition processing unit 14 uses the road data corresponding to the road along which the vehicle is currently traveling as consolidated road data.

Then, a process is carried out in which there is searched for road data connected to the road data within the consolidated road data (step ST32). Specifically, the video image composition processing unit 14 searches for road data that is connected to the consolidated road data from among the gathered road data. As used herein, “connected” means that two road data share one same endpoint.

Then, it is checked whether connected road data exists or not (step ST33). When in step ST33 it is determined that connected road data exists, the connected road data is moved to consolidated road data (step ST34). Specifically, the video image composition processing unit 14 deletes the road data found in step ST32 from the gathered road data, and adds the found road data to the consolidated road data. The sequence returns thereafter to step ST32, and the above-described process is repeated.

When in step ST33 it is determined that no connected road data exists, the consolidated road data is added to the content (step ST35). As a result, only a picture of the road as denoted by consolidated road data, namely only a road along which the vehicle can travel, excluding roads such as overpasses that are not connected to the road of interest, is overlaid onto a live-action video image in the video image composition process. This completes the content creation process.

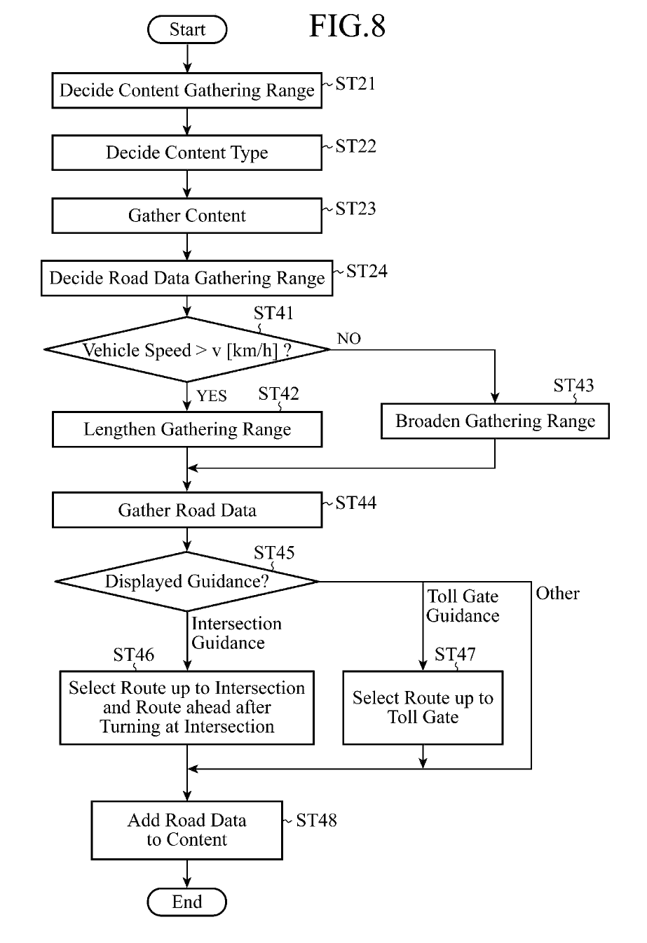

As the explanation of the aforementioned content creation process dealt only with a process under conditions wherein roads such as overpasses that are not connected to the road are eliminated, the content creation process can also be configured under other conditions, such that divided road data, resulting from dividing road data into a plurality of road data on account of the presence of a median strip, are merged together, for instance as illustrated in FIG. 7(a). Pictures of all the roads are drawn when the entirety of the road is rendered on the basis of road data, as illustrated in FIG. 7(b). By contrast, a road picture such as the one illustrated in FIG. 7(c) is drawn when road data is consolidated, for instance, in such a way so as depict only the road for which guidance is required. When the median strip is merged, there is rendered only the road along which the vehicle is traveling, plus a prolongation and side roads thereof, as illustrated in FIG. 7(d). When road data is consolidated so as to depict only the road ahead after turning at an intersection, there is rendered only a picture of the road ahead after turning at an intersection, as illustrated in FIG. 7(e).

In the car navigation device according to Embodiment 2 of the present invention, as described above, different road data exist when, for instance, a road is divided by a median strip into an up-road and a down-road. However, these road data can be merged and rendered as one single road. Alternatively, road data of roads that the vehicle cannot pass through, such as overpasses or the like, are not rendered. As a result, roads can be displayed in the same way as in an ordinary map.

### Embodiment 3

Except for the function of the road data acquisition unit 16, the configuration of the car navigation device according to Embodiment 3 of the present invention is identical to that of the car navigation device according to Embodiment 1 illustrated in FIG. 1. The road data acquisition unit 16 modifies the range over which road data is to be gathered in accordance with the vehicle speed of the vehicle.

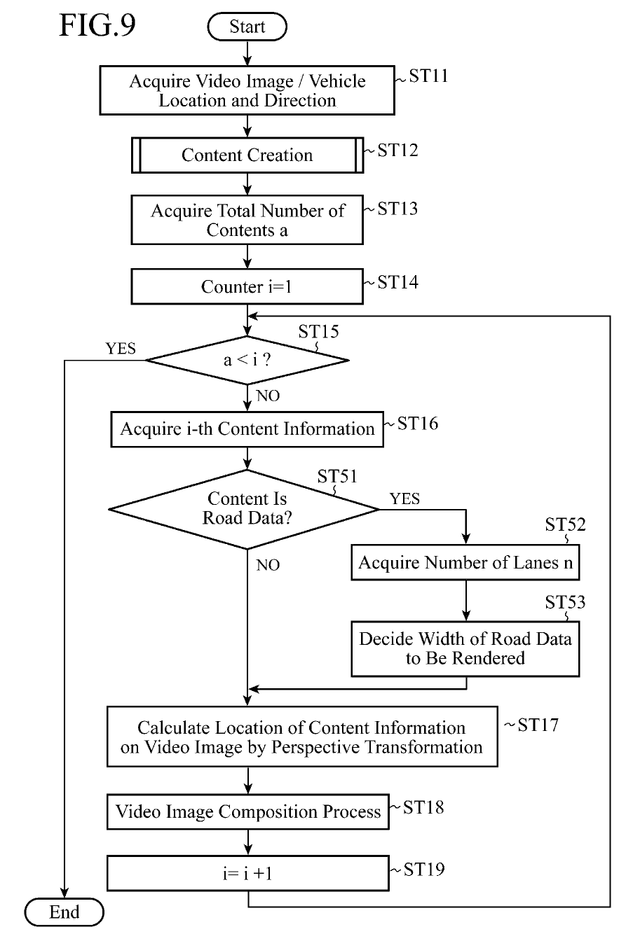

It is noted that except for the content creation process carried out in step ST12, the video image composition process performed by the car navigation device according to Embodiment 3 is identical to the video image composition process performed by the car navigation device according to Embodiment 1 illustrated in FIG. 2. In the following, the details of the content creation process that differs from that of Embodiment 1 will be described with reference to the flowchart illustrated in FIG. 8. However, the steps where the same process is carried out as in the content creation process of the car navigation device according to Embodiment 1 or Embodiment 2 described above are denoted with the same reference numerals as those used in Embodiment 1 or Embodiment 2, and the explanation thereof with be simplified.

In the content creation process, firstly, there is decided the range over which content is to be gathered (step ST21). Then, the type of content to be gathered is decided (step ST22). Then, The content is gathered (step ST23). Then, there is decided the range over which road data is to be gathered (step ST24).

Then, it is checked whether the vehicle speed is greater than a predetermined threshold value v (km/h) (step ST41). Specifically, the video image composition processing unit 14 checks whether the vehicle speed, indicated by a vehicle speed signal from the vehicle speed sensor 2, is greater than a predetermined threshold value v (km/h). The threshold value v (km/h) may be configured to be set beforehand by the manufacturer of the navigation device, or may be configured to be arbitrarily modified by the user.

When in step ST41 it is determined that the vehicle speed is greater than the predetermined threshold value v (km/h), the range over which content is to be gathered is extended longitudinally (step ST42). Specifically, the video image composition processing unit 14 doubles the range over which road data is to be gathered, as decided in step ST24, in the direction along which the vehicle is traveling, and instructs that range to the road data acquisition unit 16. It is noted that the method for extending the range over which road data is to be gathered may involve, for instance, extending the range by an arbitrary distance, for instance, 10 m in the travel direction of the vehicle. The method for extending the range over which road data is to be gathered, and the extension ratio, may be configured to be set beforehand by the manufacturer of the car navigation device, or may be configured to be arbitrarily modified by the user. A method can also be used in which, instead of extension in the travel direction of the vehicle, there is narrowed the width of the range in the left-right direction of the vehicle. Thereafter, the sequence proceeds to step ST44.

On the other hand, when in step ST41 it is determined that the vehicle speed is not greater than the predetermined threshold value v (km/h), the range over which content is to be gathered is extended laterally (step ST43). Specifically, the video image composition processing unit 14 doubles the range over which road data is to be gathered, as decided in step ST24, in the left-right direction of the vehicle, and instructs that range to the road data acquisition unit 16. It is noted that the method for expanding the range over which road data is to be gathered may involve, for instance, expanding the range by an arbitrary distance, for instance, 10 m in the left-right direction of the vehicle. The method for extending the range over which road data is to be gathered, and the extension ratio, may be configured to be set beforehand by the manufacturer of the car navigation device, or may be configured to be arbitrarily modified by the user. Thereafter, the sequence proceeds to step ST44.

Road data is gathered in step ST44. Specifically, the road data acquisition unit 16 gathers the road data present within the range extended in step ST42 or step ST43, and sends the gathered road data to the video image composition processing unit 14.

Then, the type of guidance to be displayed is checked (step ST45). When in step ST45 it is determined that the guidance to be displayed is “intersection guidance”, there is selected the route up to the intersection as well as the route ahead after turning at the intersection (step ST46). Specifically, the video image composition processing unit 14 filters the road data gathered in step ST44, and selects only road data corresponding to the route from the vehicle to the intersection, and road data of the road ahead after turning at the intersection. Thereafter, the sequence proceeds to step ST48.

When in step ST45 it is determined that the guidance to be displayed is “toll gate guidance”, there is selected a route up to a toll gate (step ST47). Specifically, the video image composition processing unit 14 filters the road data gathered in step ST44, and selects only road data corresponding to a route from the vehicle to a toll gate. Thereafter, the sequence proceeds to step ST48.

When in step ST45 it is determined that the guidance to be displayed is guidance other than “intersection guidance” and “toll gate guidance”, no route is selected, and the sequence proceeds to step ST48. In step ST48, the road data selected in step ST44, ST46 and ST47 are added to the content. This completes the content creation process.

In the above-described content creation process, the process performed by the car navigation device according to Embodiment 2, namely the process of consolidating road data in accordance with the actual road, is not carried out. However, the content creation process in the car navigation device according to Embodiment 3 may be configured to be executed in combination with the above-mentioned consolidation process.

As described above, the car navigation device according to Embodiment 3 of the present invention can be configured for instance in such a way so as to render road data over an extended range in the travel direction, when the vehicle speed is high, and over an extended range to the left and right, when the vehicle speed is low. This allows suppressing unnecessary road display, so that only the road necessary for driving is displayed.

### Embodiment 4

Except for the function of the video image composition processing unit 14, the configuration of the car navigation device according to Embodiment 4 of the present invention is identical to that of the car navigation device according to Embodiment 1 illustrated in FIG. 1. The function of the video image composition processing unit 14 is explained in detail below.

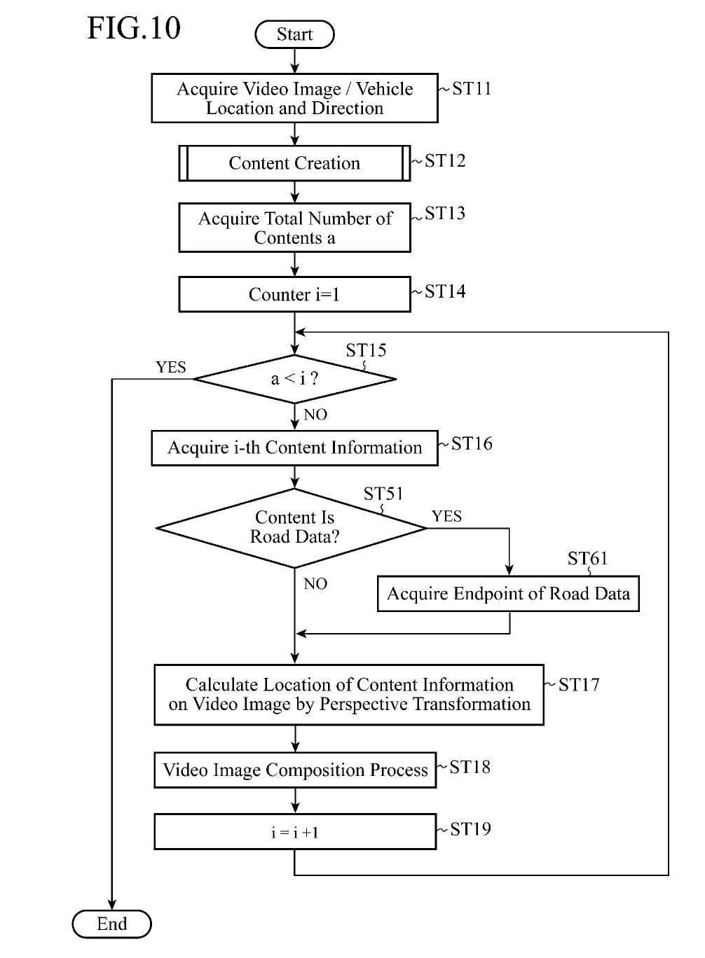

The video image composition process performed by the video image composition processing unit 14 of the car navigation device according to Embodiment 4 is identical to the video image composition process performed by the car navigation device according to Embodiment 1 illustrated in FIG. 2, except for the processing that is carried out in the case where content is road data. In the following, the video image composition process of the car navigation device according to Embodiment 4 will be described with reference to the flowchart illustrated in FIG. 9, focusing on the differences vis-à-vis Embodiment 1. However, the steps where the same processing is carried out as in the video image composition process of the car navigation device according to Embodiment 1 will be denoted with the same reference numerals used in Embodiment 1, and an explanation thereof will be simplified.

In the video image composition process, video as well as the vehicle location and direction are first acquired (step ST11). Then, content creation is carried out (step ST12). The content creation process executed in step ST12 is not limited to the content creation process according to Embodiment 1 (FIG. 4), and may be the content creation process according to Embodiment 2 (FIG. 6) or the content creation process according to Embodiment 3 (FIG. 8).

Then, the total number of contents a is acquired (step ST13). Then, the value i of the counter is initialized to “1” (step ST14). Then, it is checked whether the composition process is over for all the content information (step ST15). When in step ST15 it is determined that the composition process is over for all the content information, the video image composition process is terminated, and the video data having content composed thereinto at that point in time is sent to the display decision unit 15.

On the other hand, when in step ST15 it is determined that the composition process is not over for all the content information, an i-th content information item is then acquired (step ST16). Then, it is determined whether the content is road data (step ST51). Specifically, the video image composition processing unit 14 checks whether the content created in step ST12 is road data. When in step ST51 it is determined that the content is not road data, the sequence proceeds to step ST17.

On the other hand, when in step ST51 it is determined that the content is road data, a number of lanes n is then acquired (step ST52). Specifically, the video image composition processing unit 14 acquires the number of lanes n from the road data acquired as content information in step ST16. Then, the width of the road data to be rendered is decided (step ST53). Specifically, the video image composition processing unit 14 decides the width of the road to be rendered in accordance with the number of lanes n acquired in step ST52. For instance, the width of the road to be rendered is equated to n×10 (cm). It is note that the method for deciding the width of the road to be rendered is not limited to the above-described one, and, for instance, the value of the road width may be modified non-linearly, or may be changed to a value set by the user. Thereafter, the sequence proceeds to step ST17.

The location of the content information on the video image is calculated in step ST17 through perspective transformation. Then, the video image composition process is carried out (step ST18). Then, the value i of the counter is incremented (step ST19). Thereafter, the sequence returns to step ST15, and the above-described process is repeated.

In the above-described example, the road width to be rendered is modified in accordance with the number of lanes, which is one road attribute. However, the display format (width, color, brightness, translucence or the like) of the road to be rendered can also be modified in accordance with other attributes of the road (width, type, relevance or the like).

As described above, the car navigation device according to Embodiment 4 of the present invention is configured in such a manner that the display format (width, color, brightness, translucence or the like) of the road is modified in accordance with attributes of the road (width, number of lanes, type, relevance or the like). Therefore, one-way traffic roads can be displayed with a changed color, so that the driver can grasp at a glance not only the road around the vehicle but also information about that road.

### Embodiment 5

Except for the function of the video image composition processing unit 14, the configuration of the car navigation device according to Embodiment 5 of the present invention is identical to that of the car navigation device according to Embodiment 1 illustrated in FIG. 1. The function of the video image composition processing unit 14 is explained in detail below.

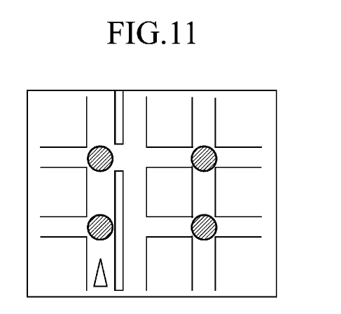

The video image composition process performed by the video image composition processing unit 14 of the car navigation device according to Embodiment 5 is identical to the video image composition process performed by the car navigation device according to Embodiment 1 illustrated in FIG. 2, except for processing in the case where content is road data. In the following, the video image composition process of the car navigation device according to Embodiment 5 will be described with reference to the flowchart illustrated in FIG. 10, focusing on the differences vis-à-vis Embodiment 1. However, the steps where the same processing is carried out as in the video image composition process of the car navigation device according to Embodiment 4 will be denoted with the same reference numerals used in Embodiment 4, and an explanation thereof will be simplified.

In the video image composition process, video images as well as the vehicle location and direction are first acquired (step ST11). Then, content creation is carried out (step ST12). The content creation process executed in step ST12 is not limited to the content creation process according to Embodiment 1 (FIG. 4), and may be the content creation process according to Embodiment 2 (FIG. 6) or the content creation process according to Embodiment 3 (FIG. 8).

Then, the total number of contents a is acquired (step ST13). Then, the value i of the counter is initialized to “1” (step ST14). Then, it is checked whether the composition process is over for all the content information (step ST15). When in step ST15 it is determined that the composition process is over for all the content information, the video image composition process is terminated, and the video data having content composed thereinto at that point in time is sent to the display decision unit 15.

On the other hand, when in step ST15 it is determined that the composition process is not over for all the content information, an i-th content information item is then acquired (step ST16). Then, it is determined whether the content is road data (step ST51). When in step ST51 it is determined that the content is not road data, the sequence proceeds to step ST17.

On the other hand, when in step ST51 it is determined that the content is road data, there is then acquired an endpoint of the road data (step ST61). Specifically, the video image composition processing unit 14 acquires an endpoint of the road data acquired in step ST16. Thereafter, the sequence proceeds to step ST17.

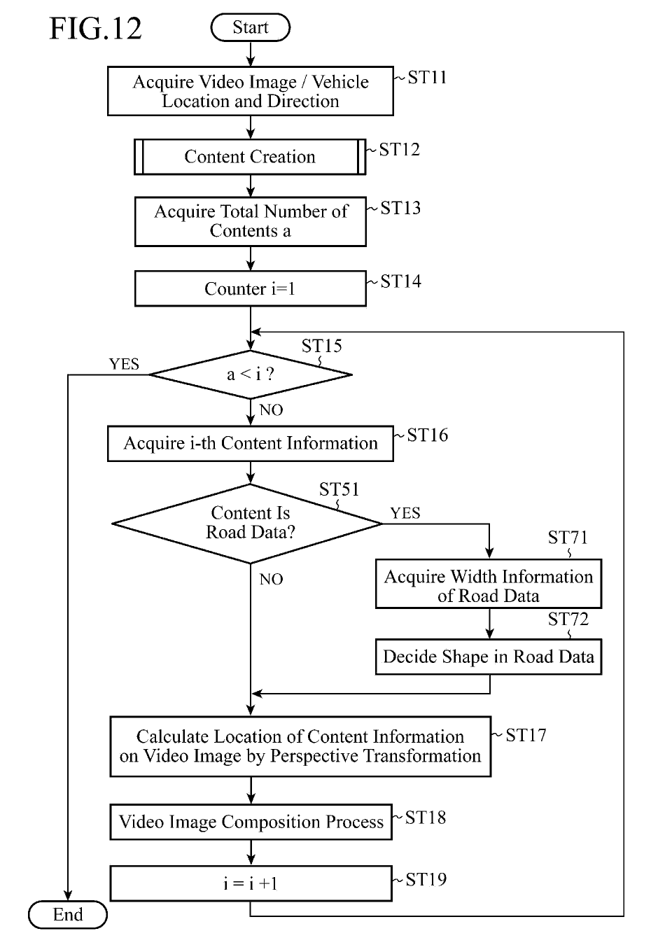

The location of the content information on the video image is calculated in step ST17 through perspective transformation. In step ST17, the video image composition processing unit 14 calculates the location, on the video image, of the endpoint of road data acquired in step ST61. Then, the video image composition process is carried out (step ST18). In step ST18, the video image composition processing unit 14 draws the endpoint of road data calculated in step ST17. As a result, intersections are rendered in the form of a predetermined graphic, as illustrated in FIG. 11. The intersection graphic can be reduced in color. The process in step ST18 is not limited to rendering of endpoints, and may be configured so as to render the road at the same time. The value i of the counter is then incremented (step ST19). Thereafter, the sequence returns to step ST15, and the above-described process is repeated.

In the example described above, endpoints alone or endpoints plus road are drawn during road rendering. However, the process can be configured in a way similar to that of the car navigation device according to Embodiment 4, in such a manner that the display format of the road (width, color, patterning such as a grid pattern, brightness, translucence and the like) and/or endpoint attributes (size, color, patterning such as a grid pattern, brightness, translucence and the like) are modified in accordance with road attributes (width, number of lanes, type, relevance and the like).

As described above, in the car navigation device according to Embodiment 5 of the present invention, road crossings (intersections) can be rendered in the form of a predetermined graphic. As a result, intersections are displayed distinctly, and the road can be grasped easily.

### Embodiment 6

Except for the function of the video image composition processing unit 14, the configuration of the car navigation device according to Embodiment 6 of the present invention is identical to that of the car navigation device according to Embodiment 1 illustrated in FIG. 1. The function of the video image composition processing unit 14 is explained in detail below.

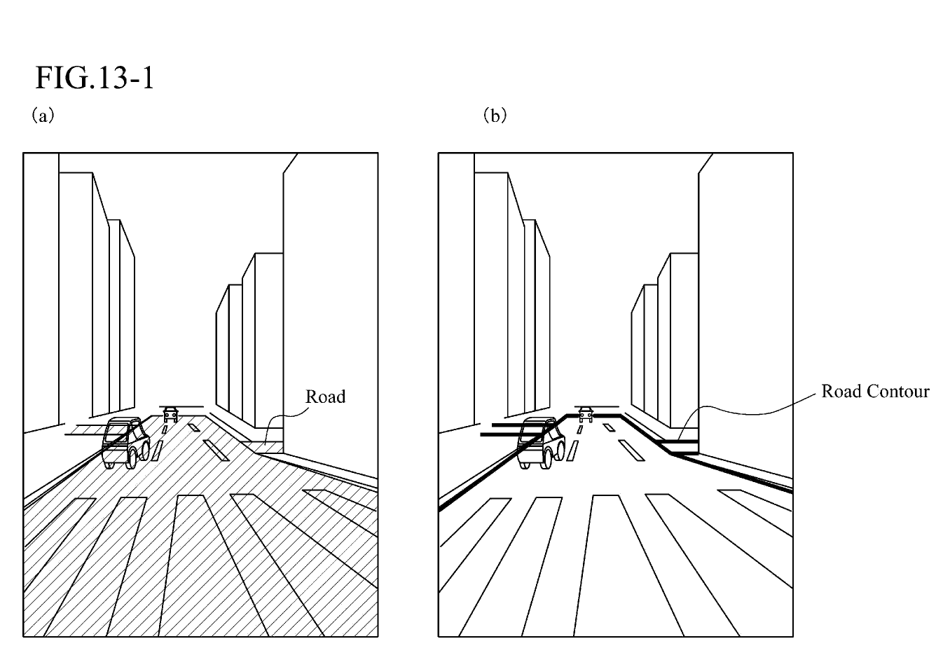

The video image composition process performed by the video image composition processing unit 14 of the car navigation device according to Embodiment 6 is identical to the video image composition process performed by the car navigation device according to Embodiment 1 illustrated in FIG. 2, except for processing in the case where content is road data. In the following, the video image composition process of the car navigation device according to Embodiment 6 will be described with reference to the flowchart illustrated in FIG. 12, focusing on the differences vis-à-vis Embodiment 1. However, the steps where the same processing is carried out as in the video image composition process of the car navigation device according to Embodiment 4 will be denoted with the same reference numerals used in Embodiment 4, and an explanation thereof will be simplified.

In the video image composition process, video images as well as the vehicle location and direction are first acquired (step ST11). Then, content creation is carried out (step ST12). The content creation process executed in step ST12 is not limited to the content creation process according to Embodiment 1 (FIG. 4), and may be the content creation process according to Embodiment 2 (FIG. 6) or the content creation process according to Embodiment 3 (FIG. 8).

Then, the total number of contents a is acquired (step ST13). Then, the value i of the counter is initialized to “1” (step ST14). Then, it is checked whether the composition process is over for all the content information (step ST15). When in step ST15 it is determined that the composition process is over for all the content information, the video image composition process is terminated, and the video data having content composed thereinto at that point in time is sent to the display decision unit 15.

On the other hand, when in step ST15 it is determined that the composition process is not completed for all the pieces of content information, an i-th content information item is then acquired (step ST16). Then, it is determined whether the content is road data (step ST51). When in step ST51 it is determined that the content is not road data, the sequence proceeds to step ST17.

On the other hand, when in step ST51 it is determined that the content is road data, there is acquired width information of the road data (step ST71). Specifically, the video image composition processing unit 14 acquires width information from the road data (road link) acquired in step ST16. The road link includes ordinarily width information, and hence width information is acquired together with the road data. However, when the road link does not include width information, the latter can be calculated indirectly on the basis of information on the number of lanes, for instance width=number of lanes×2 (m). When there is no information at all relating to width, the latter can be estimated approximately and, for instance, be set to 3 m across the board.

Then, the shape in the road data is decided (step ST72). Specifically, the video image composition processing unit 14 decides the shape of the road to be rendered on the basis of the width information acquired in step ST71. The shape of the road can be, for instance, a rectangle of the distance between road endpoints×width. The road shape is not necessarily a two-dimensional graphic, and may be a three-dimensional graphic in the form of a parallelepiped of the distance between road endpoints×width×width. Thereafter, the sequence proceeds to step ST17.

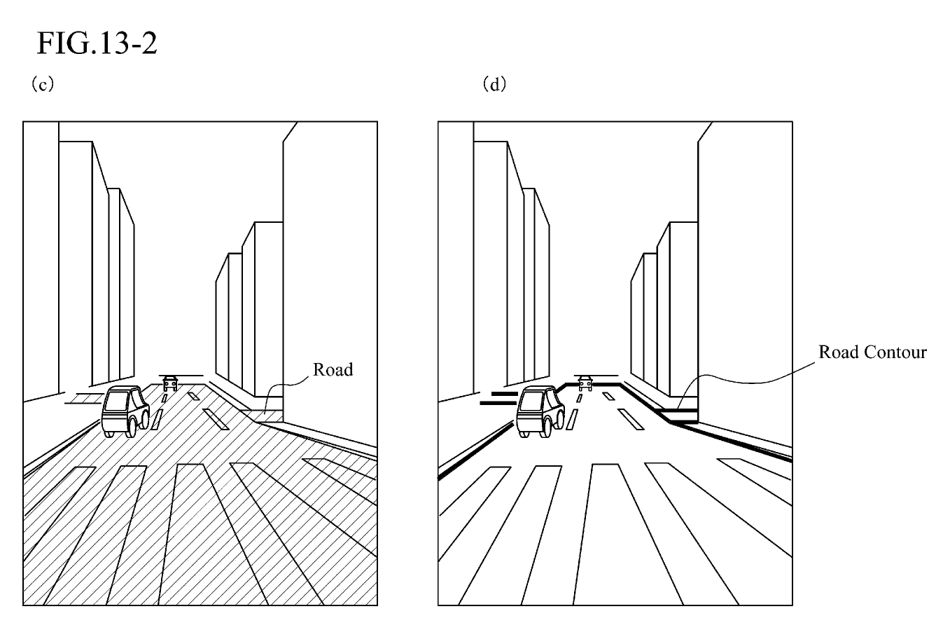

The location of the content information on the video image is calculated in step ST17 through perspective transformation. In step ST17, the video image composition processing unit 14 calculates the location on the video image of the vertices of the shape in the road data decided in step ST72. Then, the video image composition process is carried out (step ST18). In step ST18, the video image composition processing unit 14 renders the shape of the road data decided in step ST72. In such a way, a live-action video image is displayed on which there is overlaid, in the form of a CG, only a portion of the road, as illustrated in FIG. 13-1(a). The contour of the shape decided in step ST72 can also be trimmed, so that the various surfaces are rendered transparently, as illustrated in FIG. 13-1(b). Thereafter, the sequence returns to step ST15, and above-described process is repeated.

In the above description, the road is rendered onto a live-action video image. However, a process may also be carried out in which objects that are present on the road (and sidewalks) in the live-action video image, for instance vehicles, pedestrians, guardrails, roadside trees and the like, are recognized using image recognition technologies, for instance edge extraction, pattern matching and the like, such that no road is rendered on the recognized objects. This process yields display data such as that illustrated in, for instance, FIGS. 13-2(c) and 13-2(d).

In the car navigation device according to Embodiment 6 of the present invention, as described above, the road is highlighted by being overlaid, in the form of a CG, on a live-action video image, so that the driver can easily grasp the road around the vehicle. When instead of the road being overlaid by CG on the live-action video image it is the contour of the road that is displayed, the driver can easily grasp the road around the vehicle, but without the surface of the road being hidden. As a result, the user can easily evaluate the road surface in such a manner that the display is no hindrance to driving.

Also, the area of the road in the live-action video image that is overwritten or has a contour displayed thereon can be modified in accordance with the speed of the vehicle. This allows suppressing unnecessary road display, so that only the road along which the vehicle is to be driven is displayed. Further, the display format of the overlay or of the contour displayed on the road in the live-action video image can be modified in accordance with attributes of the road. This allows suppressing unnecessary road display, so that only the road along which the vehicle is to be driven is displayed.

A car navigation device used in vehicles has been explained in the embodiments illustrated in the figures. However, the car navigation device according to the present invention can also be used, in a similar manner, in other mobile objects such as cell phones equipped with cameras, or in airplanes.

### INDUSTRIAL APPLICABILITY

As described above, the navigation device according to the present invention is configured in such a manner that a picture of the road around the current position is displayed, on a display unit, overlaid on video images ahead of the vehicle that are captured by a camera. The navigation device according to the present invention can be suitably used thus in car navigation devices and the like.

1. A navigation device comprising:
a map database that holds map data;
a location and direction measurement unit that measures a current location and direction of a vehicle;
a road data acquisition unit that acquires, from the map database, map data of the surroundings of the location measured by the location and direction measurement unit, and that gathers road data from the map data;
a camera that captures video images ahead of the vehicle;
a video image acquisition unit that acquires the video images ahead of the vehicle that are captured by the camera;
a video image composition processing unit that creates a video image in which a picture of a road denoted by road data gathered by the road data acquisition unit is superimposed on the video image acquired by the video image acquisition unit by using a perspective transformation; and
a display unit that displays the video image created by the video image composition processing unit.

2. A navigation device according to claim 1, wherein the video image composition processing unit consolidates, under predetermined conditions, the road data gathered by the road data acquisition unit, and creates a video image in which a picture of a road denoted by consolidated road data is superimposed on the video image acquired by the video image acquisition unit.

3. A navigation device according to claim 1, further comprising:
a vehicle speed sensor that measures vehicle speed,
wherein the road data acquisition unit modifies a range over which road data is to be gathered from the map data held in the map database, in accordance with the vehicle speed measured by the vehicle speed sensor.

4. A navigation device according to claim 1, wherein the video image composition processing unit creates a video image in which a picture of a road denoted by road data gathered by the road data acquisition unit is superimposed on the video image acquired by the video image acquisition unit, with the picture being modified to a display format in accordance with road attributes included in the road data.

5. A navigation device according to claim 1, wherein the video image composition processing unit creates a video image in which a picture of a road denoted by road data gathered by the road data acquisition unit is superimposed on the video image acquired by the video image acquisition unit, with an intersection of the road being modified to a predetermined display format.

6. A navigation device according to claim 1, wherein the video image composition processing unit creates a video image in which a picture of a road denoted by road data gathered by the road data acquisition unit is rendered as a computer graphic, and is superimposed on the video image acquired by the video image acquisition unit.

7. A navigation device according to claim 6, wherein the video image composition processing unit creates a video image in which a picture of a road denoted by road data gathered by the road data acquisition unit is displayed in the form of the contour of the road, and is superimposed on the video image acquired by the video image acquisition unit.
